(19) United States
(12) Patent Application Publication
(10) Pub. No.: US 2016/0265724 A1
(43) Pub. Date: Sep. 15, 2016

(54) POLYMER COMPOSITE PRESSURE VESSELS USING ABSORBENT TECHNOLOGY

(71) Applicant: PANGAEA ENERGY LIMITED, Newfoundland and labradore (CA)

(72) Inventors: Brian E. Spencer, Sacramento, CA (US); Darrell Hawkins, Newfoundland and Labrador (CA); Zachary B. Spencer, Sacramento, CA (US); Brendan Harvey, Newfoundland and Labrador (CA)

(21) Appl. No.: 15/032,621

(22) PCT Filed: Oct. 16, 2014
(86) PCT No.: PCT/IB2014/002401

§ 371 Date: Apr. 27, 2016

Related U.S. Application Data
(60) Provisional application No. 61/891,854, filed on Oct. 16, 2013.

(51) Int. Cl. F17C 11/00; F17C 1/16

(52) U.S. Cl. CPC F17C 11/007; F17C 1/16; F17C 2201/0128; F17C 2203/0604; F17C 2203/066; F17C 2203/0673; F17C 2203/0656; F17C 2221/033; F17C 2270/0168; F17C 2270/0709

(57) ABSTRACT

This invention is directed to composite pressure vessels for the storage and transport of natural gas at low pressure using absorbent technology. The pressure vessel comprises a polymeric liner that defines an interior vessel volume, a polymeric composite outer shell that substantially completely encloses the polymeric liner; an absorbent that substantially fills the interior vessel volume; and a port that connects the interior vessel volume with the external environment.

### FIELD

This invention relates to composite pressure vessels for containing gases, in particular natural gas (NG, predominantly methane), at low pressure using absorbent technology.

### BACKGROUND

Nearly 3 billion people each day cook on open fires or rudimentary cookstoves fueled by coal or solid biomass such as wood. The detrimental effects of burning solid fuels on the environment and human health are staggering. The Global Burden of Disease Study 2010 estimates that exposure to smoke from the simple act of cooking using coal or solid biomass is the fourth worst risk factor for disease in developing countries, and causes four million premature deaths per year, which exceeds the number of deaths attributable to malaria or tuberculosis. In addition, tens of millions more fall sick with illnesses that could readily be prevented using clean and efficient cooking solutions. In addition, reliance on polluting cookstoves and fuels leads to a wide variety of environmental problems. For example, using solid biomass as fuel depletes forests, which may weaken the soil causing mudslides and destroying agricultural land. The Global Alliance for Clean Cook Stoves (GACC.org) is leading the effort to provide clean fuel alternatives. It its mission statement, the GACC notes that:
cookstove smoke-impacted households are often located in rural and remote locations, which present challenges for reaching those customers with clean cookstoves and fuel in the so-called ‘last mile’ before the product reaches the consumers' door. The size, weight, and fragility of clean cookstoves often provide distribution and logistical challenges. Other factors such as consumer price sensitivity, deeply ingrained cultural preferences, gender bias, and the need for both scalability and customization must be considered when developing mechanisms for reaching the end user.

The problem then is to develop a technology directed to an economical readily distributable and transportable by human or animal effort only, safe and easy to use, low-polluting source of energy for use in numerous individual tasks such as cooking. The technology should be readily adaptable for use virtually anywhere on earth but particularly in developing nations where the need is most urgent. The present invention provides a unique solution to the problem.

### SUMMARY

Thus, an aspect of this invention comprises a man- or animal- portable low-pressure natural gas storage and transport vessel, comprising:
a polymeric liner that defines an interior vessel volume;
a polymeric composite outer shell that substantially completely encloses the polymeric liner;
an absorbent that substantially fills the interior vessel volume; and
a port that connects the interior vessel volume with the external environment.

In an aspect of this invention, the polymeric liner is selected from the group consisting of high density polyethylene and polydicyclopentadiene.

In an aspect of this invention, the polymeric composite comprises a filamentous material impregnated with or embedded in or both impregnated with and embedded in a polymeric matrix.

In an aspect of this invention, the filamentous material is selected from the group consisting of a natural fiber, a metal, a glass, a ceramic, a synthetic polymer and combinations thereof.

In an aspect of this invention, the filamentous material is selected from the group consisting of fiberglass, carbon fibers, aramid fibers and ultra-high molecular weight polyethylene.

In an aspect of this invention, the polymeric matrix is selected from the group consisting of a thermoplastic polymer, a thermoplastic elastomer, a thermoset polymer and combinations thereof.

In an aspect of this invention, the thermoset polymer is selected from the group consisting of an epoxy polymer, a polyester polymer, a vinyl ester polymer, a polyimide and dicyclopentadiene.

In an aspect of this invention, the thermoset polymer is dicyclopentadiene.

In an aspect of this invention, the absorbent is selected form the group consisting of a pellet absorbent, a granular absorbent, a powder absorbent and any combination thereof.

In an aspect of this invention, the pellet absorbent, the granular absorbent and the powder absorbent are porous.

In an aspect of this invention, the absorbent comprises a pellet absorbent, a granular absorbent, a powder absorbent, a porous pellet absorbent, a porous granular absorbent, a porous powder absorbent or any combination of the foregoing.

In an aspect of this invention, the absorbent comprises an absorbent selected from the group consisting of a pellet absorbent, a granular absorbent, a porous pellet absorbent, a granular absorbent and any combination of these together with a powder absorbent, a porous powder absorbent or a combination of these.

In an aspect of this invention, the absorbent is selected from the group consisting of an activated carbon absorbent, a zeolite absorbent, a molecular sieve absorbent, a metal organic framework absorbent and combinations thereof.

In an aspect of this invention, the storage and transport vessel is spherical in shape.

In an aspect of this invention, the vessel is used as an energy source for indoor or outdoor cooking, barbequing, heating or motorized transportation.

An aspect of this invention comprises a low-pressure composite natural gas or hydrogen storage and transport vessel for use with a motorized transportation vehicle, comprising:
a polymeric liner that defines an interior vessel volume;
a polymeric composite outer shell that substantially completely encloses the polymeric liner;
an absorbent that substantially fills the interior vessel volume; and
a port that connects the interior vessel volume with the external environment.

### DETAILED DESCRIPTION

The current GACC-preferred alternative to coal and biomass fuel is LPG, liquefied petroleum gas, sometimes referred to simply as propane. On the other hand, natural gas (NG), i.e., predominantly methane, is the cleanest burning of all fossil fuels, is energy-efficient, is substantially less expensive than other fossil fuels including propane and, importantly, is readily locally available in most developing nations where the need is most critical. The present invention, thus, is directed to a relatively light-weight, high capacity, man- or animal- portable, NG storage and transportation system that uses absorbent technology. Such systems, often referred to with regard to NG as ANG or absorbed natural gas systems, in addition to the foregoing beneficial characteristics, will operate at pressures approved for operation of coupling/ uncoupling devices by untrained personnel.

The discussion that follows is directed to ANG-powered cooking systems although it is understood that the technology disclosed will find use in numerous other applications such as, without limitation, heating systems, power generation and, in particular as a fuel source for natural gas powered vehicles such as, again without limitation, automobiles (the NGV market), marine engines including outboard motors and small personal vehicles such as, without limitation, motorcycles, three-wheeled vehicles and mopeds. Using the information disclosed in this specification, those skilled in the art will be able to modify the configuration of a composite, absorbent-containing storage and transport vessel of this invention for the preceding and many other uses. With regard to vehicles for transportation, the present invention is directed to refillable permanently installed containment vessels such as may be found in cars, trucks, etc. as well as “swap and go” systems wherein small composite, absorbent-containing vessels are used and then, when exhausted, simply removed and replaced with a full vessel.

A fundamental feature of the systems of the present invention is the use of a composite pressure vessel containing an NG absorbent. As mentioned previously, absorbed NG is generally referred to as “ANG.” A composite pressure vessel provides a relatively light weight containment vessel for ANG which will be make cooking equipment easy to carry and set up using human or animal power alone. The absorbent provides a means for loading NG into a vessel in quantities equivalent to that loaded into a vessel without absorbent, but at a fraction of the pressure. That is, when a vessel with a selected absorbent is used, the NG near the absorbent particle surface undergoes a phase change from the gaseous state to an absorbed state causing fluid densities to approach that of NG in a liquid state. The resulting reduction in pressure of the same amount of gas in the same size vessel is exceptional: NG is commonly supplied as compressed NG, termed CNG, at approximately 3600 psi and the containment vessels for CNG reflect the high pressure in that they are generally heavy, relatively thick-walled metal vessels. On the other hand, an equivalent amount of NG supplied as ANG would require a vessel capable of withstanding only about 600 psi. Thus, the ANG vessel would be expected to be substantially less expensive and, ultimately, safer than current LPG and CNG vessels. Under certain circumstances such as, without limitation, compared to a metal vessel of the same volume containing an absorbent, the vessel of the current invention may also be significantly lighter. Households that are currently using LPG could be easily converted to ANG. The current cost of LPG is several times the cost of NG. Households using LPG generally employ 3 Kg and 6 Kg containers that are exchanged at a local filling station. The same approach could be used for ANG containers. Some developing countries subsidize the cost of LPG to make it affordable for the population. Examples of countries that would greatly benefit from this technology include Indonesia, Bangladesh, India and China. Much of the LPG is imported to these countries. On the other hand these countries have large underutilized NG reserves. Thus, it is expected that the technology herein might be well accepted in those nations currently reliant on LPG and governmental participation may render the technology even more available and affordable.

As used herein, the term “low pressure” refers to a storage and transportation pressure vessel of this invention that, when loaded with a gas, which is absorbed onto an absorbent, for example, without limitation, ANG, will exhibit a substantially lower pressure than a pressure vessel of the same volume loaded with an equivalent amount of the same gas but not containing an absorbent.

An embodiment of this invention is a relatively small capacity pressure vessel, for example, without limitation, a 15 liter NG storage and transportation system for use with stoves such as, again without limitation, indoor cook stoves, outdoor camp stoves, BBQs and any other devices currently reliant on biomass, kerosene and LPG as a fuel.

Current ANG technology in commercial operations has focused on proprietary adsorbents as exemplified by Energtek and repurposing existing steel pressure vessels such as the G-Tec system. The system herein, on the other hand uses polymeric composite pressure vessels as storage and transport vessels for ANG wherein the system is optimized for adsorbent characteristics while being customized to the intended market.

In an embodiment of this invention, the system will comprise a polymer-lined polymeric composite pressure vessel filled with an absorbent designed for optimal absorption of methane or other gas such as hydrogen. The vessel could be containerized to allow ease of handling, such as a barbeque grill LPG container.

A pressure vessel of this invention will in general comprise a pre-formed polymeric liner around which a polymeric composite is wrapped to form the completed vessel.

As used herein, to “wrap” a polymeric liner refers to the winding of a filamentous material around a liner fabricated in the desired shape of the end product vessel, which may be, without limitation, cylindrical, geodesic, toroidal, spherical or oblate spheroidal. Presently preferred is a spherical liner which, at present reduces cost of material and manufacturing. The filamentous material may be wound around the construct in a dry state and left as such or it may subsequently be impregnated with a polymeric matrix or covered with a polymeric protective layer. Alternatively, the filamentous material may be impregnated with a polymeric matrix prior to being wound onto a liner construct and thereby becomes embedded in excess matrix material.

The polymeric liner around which the polymeric composite is wrapped can be any polymer that can be formed into the appropriate shape and that is inert to the gas to be contained in the vessel. Examples of suitable polymers for use as liners for ANG vessels are, without limitation, high density polyethylene and polydicyclopentadiene.

As used herein, a “polymeric composite” has the meaning that would be ascribed to it by those skilled in the art. In brief, it refers to a fibrous or filamentous material that is impregnated with, embedded in or both impregnated with and embedded in or enveloped by a polymer matrix material.

In general, any type of fibrous or filamentous material may be used to create the polymeric composites of this invention. Such materials include, without limitation, natural fibers such as, without limitation, silk, hemp, flax, etc., metals, ceramics, basalt and synthetic polymer fibers and filaments. Examples of such materials include, without limitation, glass fibers, commonly known as fiberglass, carbon fibers, aramid fibers, which go mostly notably under the trade name Kevlar® and ultra-high molecular weight polyethylene, such as Spectra® (Honeywell Corporation) and Dyneeva® (Royal DSM N.V.).

The matrix in which the filamentous or fibrous material is impregnated or enveloped or both impregnated and enveloped can comprise thermoplastic polymers, thermoplastic elastomers, thermoset polymers and combinations thereof. Of particular note are thermoset polymers, which can exhibit significantly better mechanical properties, chemical resistance, thermal stability and overall durability than the other types of polymers.

A particular advantage of most thermoset plastics or resins is that their precursor monomers or prepolymers generally tend to have relatively low viscosities under ambient conditions of pressure and temperature and therefore can be introduced into or combined with fibers and filaments quite easily.

Another advantage of thermoset polymers is that they can usually be chemically cured isothermally, that is, at the same temperature at which they are combined with the fibers/filaments, which can be room temperature.

Suitable thermoset polymers include, without limitation, epoxy polymers, polyester polymers, vinyl ester polymers, polyimide polymers, dicyclopentadiene (DCPD) polymers and combinations thereof.

The polymeric composite may be wrapped around the liner in a relatively straight forward manner referred by those skilled in the art as “hoop-wrapping.” On the other hand, to assure a vessel has the requisite strength to contain the NG, the liner may be wrapped in addition to hoop-wrapping, sometimes in lieu of hoop-wrapping, in a manner called “isotensoidal wrapping,” which is likewise well-known in the art. Briefly, “isotensoidal wrapping” refers to the property of the fully wound vessel in which each filament of the wrap experiences a constant pressure at all points in its path. This is currently considered a desirable design for a polymeric composite wrapped pressure vessel because, in this configuration, virtually the entire stress imposed on the vessel by a compressed gas is assumed by the filaments of the composite with very little of the stress being assumed by the polymeric matrix or the liner.

The absorbent for the NG may be in pellet or granular form, a porous pellet or porous granular form, a powder and any combination of the foregoing. A mixture of a pellet, a granular, a porous pellet or a porous granular absorbent or any combination of the foregoing together with a powder form absorbent is presently preferred. It is believed that this combination of absorbent particle forms will result in a more efficient packing in the pressure vessel. Absorbents such as, without limitation, commercially available activated carbons, zeolites, molecular sieves, etc. may be used. Suitable absorbents are currently commercially available from, without limitation, the Cabot Corporation, Boston, Mass.

The invention herein will additionally comprise, without limitation, features such sensors to monitor temperature, pressure, cycle life, fill rate and location (GPS) of the vessels. Such devices will include, without limitation, pressure regulators, control valves, etc. These devices and others like them are well-known in the art and need no further description or discussion. The additional features of a system of this invention will be coupled to the primary composite ANG vessel by means of a port that couples the interior volume of the vessel with the external environment. The port can include any of the multitude of devices for coupling the port, and thence the interior volume of the pressure vessel, with any of the foregoing features.

In addition, methods of loading the ANG pressure vessels will be an aspect of this invention. Such methods may include manual loading or automated method as such are available in modern packaging plants.

It is understood that, with regard to this description and the appended claims, reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise. In particular, when referring to a liner of this invention being “substantially completely” enclosed by a composite outer shell, the use of “substantially” means that, while it is presently preferred that the liner in fact be completely enclosed by the composite shell, either hoop-wrapped, isotensoidally-wrapped or a combination of the two methods of wrapping, it is possible that some portion of the shell may be left exposed to the external environment but such constructs are still within the scope of this invention. Likewise, to be “substantially filled” with an absorbent means that it is presently preferred that the interior volume a vessel of this invention be filled with a pelletized, granular or powdered absorbent such that there is minimal free volume space in the vessel. In fact, it is presently most preferred that a combination of a pelletized or granular absorbent or a combination of a pelletized and a granular absorbent be mixed with a powered absorbent to fill in the free volume between the pellets, the granules or the pellets and the granules to limit the free space as much as possible. It is, however, within the scope of this invention that the interior volume contains any combination of pellets, granules and powder absorbent which may leave free volume open. In addition, it is possible that some head space may occur in a vessel and such is still within the scope of this invention as indicated by the use of the word “substantially.

As used herein, the use of “preferred,” “preferably,” or “more preferred,” and the like refers to preferences as they existed at the time of filing of this patent application.

What is claimed:

1. A man- or animal-portable low-pressure natural gas storage and transport vessel, comprising:
a polymeric liner that defines an interior vessel volume;
a polymeric composite outer shell that substantially completely encloses the polymeric liner;
an absorbent that substantially fills the interior vessel volume; and
a port that connects the interior vessel volume with the external environment.

2. The storage and transport vessel of claim 1, wherein the polymeric liner is selected from the group consisting of high density polyethylene and polydicyclopentadiene.

3. The storage and transport vessel of claim 1, wherein the polymeric composite comprises a filamentous material impregnated with or embedded in or both impregnated with and embedded in a polymeric matrix.

4. The storage and transport vessel of claim 3, wherein the filamentous material is selected from the group consisting of a natural fiber, a metal, a glass, a ceramic, a synthetic polymer and combinations thereof.

5. The storage and transport vessel of claim 4, wherein the filamentous material is selected from the group consisting of fiberglass, carbon fibers, aramid fibers and ultra-high molecular weight polyethylene.

6. The storage and transport vessel of claim 3, wherein the polymeric matrix is selected from the group consisting of a thermoplastic polymer, a thermoplastic elastomer, a thermoset polymer and combinations thereof.

7. The storage and transport vessel of claim 6, wherein the thermoset polymer is selected from the group consisting of an epoxy polymer, a polyester polymer, a vinyl ester polymer, a polyimide and dicyclopentadiene.

8. The storage and transport vessel of claim 7, wherein the thermoset polymer is dicyclopentadiene.

9. The storage and transport vessel of claim 1, wherein the absorbent is selected form the group consisting of a pellet absorbent, a granular absorbent, a powder absorbent and any combination thereof.

10. The storage and transport vessel of claim 9, wherein the pellet absorbent, the granular absorbent and the powder absorbent are porous.

11. The storage and transport vessel of claim 1, wherein the absorbent comprises a pellet absorbent, a granular absorbent, a powder absorbent, a porous pellet absorbent, a porous granular absorbent, a porous powder absorbent or any combination of the foregoing.

12. The storage and transport vessel of claim 11, wherein the absorbent comprises an absorbent selected from the group consisting of a pellet absorbent, a granular absorbent, a porous pellet absorbent, a granular absorbent or any combination of these together with a powder absorbent or a porous powder absorbent.

13. The storage and transport vessel of claim 11, wherein the absorbent is selected from the group consisting of an activated carbon absorbent, a zeolite absorbent, a molecular sieve absorbent, a metal organic framework absorbent and combinations thereof.

14. The storage and transport vessel of claim 1, wherein the vessel is used as an energy source for indoor or outdoor cooking, barbequing, heating or motorized transportation.

15. The storage and transport vessel of claim 1, wherein the storage and transport vessel is spherical in shape.
